(19) United States
(12) Patent Application Publication
(10) Pub. No.: US 2026/0105772 A1
(43) Pub. Date: Apr. 16, 2026

(54) LIVENESS DETECTION CIRCUIT, METHOD, AND BIOMETRIC RECOGNITION DEVICE

(71) Applicant: Silead Inc., Shanghai (CN)

(72) Inventors: Jinling Zhou, Shanghai (CN); Jun Yang, Shanghai (CN); Wei Su, Shanghai (CN)

(21) Appl. No.: 19/335,811

(22) Filed: Sep. 22, 2025

(30) Foreign Application Priority Data
Oct. 14, 2024 (CN) CN202411433534.3

(51) Int. Cl. G06V 40/13; G06V 40/12; G06V 40/40

(52) U.S. Cl. CPC G06V 40/1306; G06V 40/1365; G06V 40/1382; G06V 40/45

(57) ABSTRACT

The embodiments of the present disclosure provide a liveness detection circuit, a liveness detection method and a biometric recognition device. In which, the liveness detection circuit includes a signal generation module, and a detection module with an induction assembly; wherein the signal generation module is configured to generate a first voltage signal; and the detection module is configured to detect a second voltage signal generated when an object to be detected approaches the induction assembly, based on the first voltage signal, and judge whether the object to be detected is alive based on the first voltage signal and the second voltage signal. By disposing the induction assembly, the detection module may detect whether the object to be detected is active through a non-contact detection solution, thereby improving the security and the reliability of the biometric detection.

### CROSS-REFERENCE TO RELATED APPLICATION

This application claims priority to Chinese Patent Application No. 202411433534.3, filed on Oct. 14, 2024, which is hereby incorporated by reference in its entirety.

### TECHNICAL FIELD

The present disclosure relates to the technical field of biological information detection, and particularly to a liveness detection circuit, method, and a biometric recognition device.

### BACKGROUND

The security of the biometric chips is one of the key concerns of users using electronic devices. The false acceptance rate and the false rejection rate are the most important indicators to measure the security of the biometric chips.

Taking the fingerprint chip as an example, the traditional fingerprint identification chip usually only collects the ridge-valley information of a finger to form a fingerprint pattern, and it is difficult to achieve absolute security by deciding whether to unlock by determining the matching degree between a reference template and the captured fingerprint. For example, when the fingerprint information of the owner is acquired by illegal means, it is possible to pass the fingerprint identification.

### SUMMARY

The embodiments of the present disclosure aim to provide a liveness detection circuit, a liveness detection method, and a biometric recognition device.

A first aspect of the present disclosure provides a liveness detection circuit, including: a signal generation module, and a detection module with an induction assembly; wherein,
the signal generation module is configured to generate a first voltage signal; and
the detection module is configured to detect a second voltage signal generated when an object to be detected approaches the induction assembly based on the first voltage signal, and judge whether the object to be detected is alive based on the first voltage signal and the second voltage signal.

In some embodiments of the present disclosure, the induction assembly includes an induction coil, an impedance of the induction coil changes when the object to be detected approaches.

In some embodiments of the present disclosure, the detection module includes a detection and amplifier unit, and a processing unit, and the induction assembly includes an induction coil;
an output end of the signal generation module is connected to a first end of the induction coil and a first input end of the detection and amplifier unit, a second input end of the detection and amplifier unit is grounded, a second end of the induction coil is connected to an output end of the detection and amplifier unit, and the output end of the detection and amplifier unit is connected to the processing unit;
the detection and amplifier unit is configured to detect and amplify a voltage across the induction coil and output the second voltage signal, and the processing unit is configured to judge whether the object to be detected is alive, based on the first voltage signal and the second voltage signal; and the induction coil is configured to generate excitation current, based on the first voltage signal, in which the generate excitation current is alternating current.

In some embodiments of the present disclosure, the induction assembly further includes an induction capacitor; a first end of the induction capacitor is connected to the first end of the induction coil, and a second end of the induction capacitor is connected to the second end of the induction coil.

In some embodiments of the present disclosure, the induction assembly further includes a switch and an induction capacitor; and in which a first end of the switch is connected to the first end of the induction coil, a second end of the switch is connected to a first end of the induction capacitor, and a second end of the induction capacitor is connected to the second end of the induction coil.

In some embodiments of the present disclosure, the detection and amplifier unit includes a first operational amplifier, in which a negative input end of which is connected to the first end of the induction coil and the output end of the signal generation module, a positive input end of the first operational amplifier is grounded, and an output end of the first operational amplifier is connected to the second end of the induction coil and the processing unit.

In some embodiments of the present disclosure, in which the processing unit includes a processor configured to determine an impedance of the induction coil based on the first voltage signal and the second voltage signal, and judge whether the object to be detected is alive based on the impedance of the induction coil and a preset impedance.

In some embodiments of the present disclosure, the processing unit includes a peak value detection unit and an analog-to-digital conversion unit; the peak value detection unit is configured to detect a peak value of the second voltage signal output by the detection and amplifier unit, and retain the peak value; the analog-to-digital conversion unit is configured to quantize the peak value to obtain a target signal, and send the target signal to an operation module of the processor, so that the operation module of the processor determines an impedance of the induction coil based on the target signal and the first voltage signal, and judges whether the object to be detected is alive based on the impedance of the induction coil and a preset impedance. That is to say, the processing unit comprises a processor configured to perform peak value detection and analog-to-digital conversion; and performing peak value detection comprises detecting a peak value of the second voltage signal output by the detection and amplifier unit, and retaining the peak value; and performing analog-to-digital conversion comprises quantizing the peak value to obtain a target signal, and sending the target signal to an operation module of the processor, so that the operation module of the processor determines an impedance of the induction coil based on the target signal and the first voltage signal, and judges whether the object to be detected is alive based on the impedance of the induction coil and a preset impedance.

In some embodiments of the present disclosure, the peak value detection and holding subunit includes a first diode, a second diode, a detection resistor, a detection capacitor, a second operational amplifier and a third operational amplifier;
a negative input end of the second operational amplifier is connected to an anode of the first diode and a first end of the detection resistor, a positive input end of the second operational amplifier is connected to the output end of the detection and amplifier unit, and an output end of the second operational amplifier is connected to a positive input end of the third operational amplifier through the second diode;
a cathode of the first diode is connected to the output end of the second operational amplifier;
a second end of the detection resistor is connected to a negative input end of the third operational amplifier and an output end of the third operational amplifier; and
a positive input end of the third operational amplifier is grounded through the detection capacitor, and the output end of the third operational amplifier is connected to an input end of the analog-to-digital conversion subunit.

In some embodiments of the present disclosure, the signal generation module includes a frequency-adjustable sine wave generator configured to output a fixed-frequency sine wave or a variable-frequency sine wave.

A second aspect of the present disclosure provides a liveness detection method, which is applied to the liveness detection circuit according to the first aspect, including:
generating, by a signal generation module, a first voltage signal;
detecting, by a detection module, a second voltage signal generated when an object to be detected approaches an induction assembly, based on the first voltage signal, and judging whether the object to be detected is alive based on the first voltage signal and the second voltage signal.

In some embodiments of the present disclosure, the generating, by a signal generation module, a first voltage signal includes:
generating, by the signal generation module, a first voltage signal characterized by a variable-frequency sine wave;
accordingly, the judging, by the detection module, whether the object to be detected is alive based on the first voltage signal and the second voltage signal includes:
detecting, by the detection module, a peak value of the second voltage signal output by the induction assembly based on the first voltage signal, performing analog-to-digital conversion on the detected peak value, and determining a maximum value of the peak value as the second voltage signal based on an analog-to-digital conversion result;
calculating, by the detection module, a first impedance of the induction assembly based on the second voltage signal and the first voltage signal corresponding to the maximum value of the peak value; and
judging, by the detection module, whether the object to be detected is alive based on the first impedance of the induction assembly and a first preset impedance.

In some embodiments of the present disclosure, the generating, by a signal generation module, a first voltage signal includes:
generating, by the signal generation module, a first voltage signal characterized as a fixed-frequency sine wave;
accordingly, the judging, by the detection module, whether the object to be detected is alive based on the first voltage signal and the second voltage signal includes:
detecting, by the detection module, a peak value of the second voltage signal output by the induction assembly based on the first voltage signal, and performing analog-to-digital conversion on the peak value to obtain the second voltage signal;
calculating, by the detection module, a second impedance of the induction assembly based on the second voltage signal and the first voltage signal corresponding to the peak value; and
judging, by the detection module, whether the object to be detected is alive based on the second impedance of the induction assembly and a second preset impedance.

A third aspect of the present disclosure provides a biometric recognition device, including: the liveness detection circuit according to the first aspect, and a biometric sensing chip;
the biometric sensing chip is configured to sense an object to be detected through a chip sensing area, and judge whether biological characteristics carried by the object to be detected matches preset biological characteristics; and
the liveness detection circuit is configured to generate a first voltage signal; detect a second voltage signal generated when the object to be detected approaches an induction assembly based on the first voltage signal, and judge whether the object to be detected is alive based on the first voltage signal and the second voltage signal.

In some embodiments of the present disclosure, the biometric sensing chip and an induction coil in the liveness detection circuit are disposed horizontally.

### BRIEF DESCRIPTION OF THE DRAWINGS

In order to more clearly explain the technical solutions in the embodiments of the present disclosure or in the prior art, the drawings to be used in the description of the embodiments or the prior art will be briefly introduced as follows. Obviously, the drawings concerned in the following description only illustrate some embodiments of the present disclosure, and those of ordinary skill in the art can obtain other drawings from them without paying any creative labor.

FIG. 1 illustrates a schematic diagram of a liveness detection circuit according to an embodiment of the present disclosure;

FIG. 2 illustrates a schematic diagram of an eddy current effect according to an embodiment of the present disclosure;

FIG. 3 illustrates a schematic diagram of a detection module according to an embodiment of the present disclosure;

FIG. 4a and FIG. 4b illustrates another schematic diagram of a detection module according to an embodiment of the present disclosure;

FIG. 5 illustrates still another schematic diagram of a detection module according to an embodiment of the present disclosure;

FIG. 6 illustrates a schematic diagram of a liveness detection circuit according to an embodiment of the present disclosure;

FIG. 7 illustrates a schematic diagram of a peak value detection and holding subunit according to an embodiment of the present disclosure; and

FIG. 8 illustrates a schematic diagram of a biometric recognition device according to an embodiment of the present disclosure.

### DETAILED DESCRIPTION OF THE EMBODIMENTS

The technical solutions in the embodiments of the present disclosure will be clearly and completely described below in conjunction with the drawings for the embodiments of the present disclosure. Obviously, those described are merely part, rather than all, of the embodiments of the present disclosure. Based on the embodiments of the present disclosure, any other embodiment obtained by those of ordinary skill in the art without paying any creative labor should fall within the protection scope of the present disclosure.

As mentioned above, at present, the solution that can realize both the fingerprint identification and the liveness detection is an optical fingerprint chip, which realizes the liveness detection by detecting a fingerprint pulse, and neither an ultrasonic fingerprint chip nor a capacitive fingerprint chip achieves the liveness detection. However, the optical fingerprint chip available for detecting a living body at present has a complex structure and a high cost, while other types of fingerprint chips cannot detect the pulse, so the security, reliability and applicability of the fingerprint detection are low.

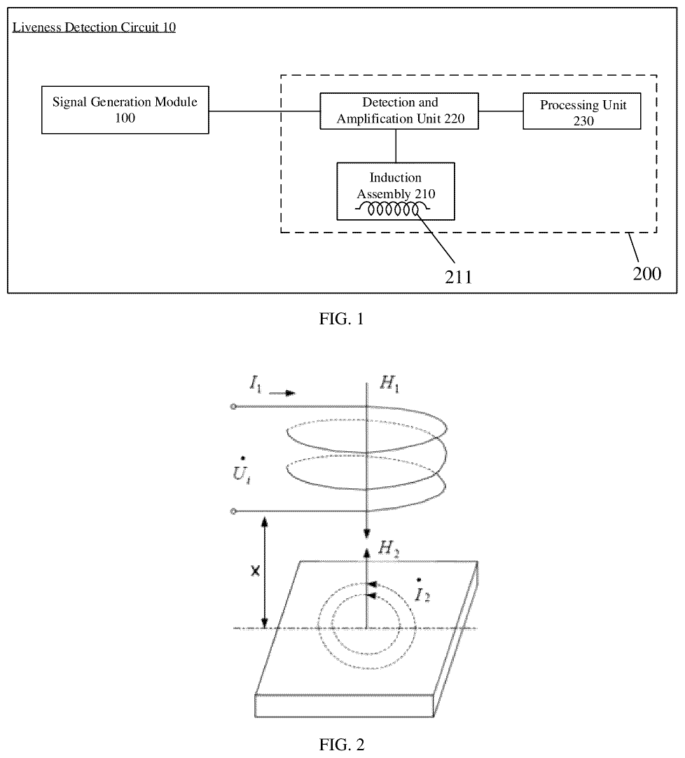

In order to solve the above problems, the embodiments of the present disclosure provide a liveness detection circuit, which is introduced below with reference to FIG. 1.

As illustrated in FIG. 1, the embodiments of the present disclosure provide a liveness detection circuit 10, which may include a signal generation module 100, and a detection module 200 provided with an induction assembly 210.

In which, the signal generation module 100 is configured to generate a first voltage signal; the detection module 200 is configured to detect a second voltage signal generated when an object to be detected approaches the induction assembly 210 based on the first voltage signal, and judge whether the object to be detected is alive based on the first voltage signal and the second voltage signal.

It can be understood that the signal generation module 100 may be configured to generate a voltage, i.e., a first voltage signal, for the detection module 200 to detect whether the object to be detected is alive. Exemplarily, when the detection module 200 detects whether the object to be detected is alive, the induction assembly may detect a change of the voltage when the object to be detected approaches, based on the first voltage signal generated by the signal generation module 100, i.e., the detection module 200 detects a second voltage signal generated when the object to be detected approaches the induction assembly 210, and then the detection module 200 may judge whether the object to be detected is alive based on the first voltage signal and the second voltage signal. In which, whether the object to be detected is alive may have different meanings for different test scenarios. For example, for a scenario of fingerprint detection, whether the finger is a human finger, i.e., whether the liveness at this time is caused by a human finger, may be judged by the liveness detection circuit in the embodiments of the present disclosure. Of course, for other application scenarios, judging whether the object to be detected is alive may be understood as representing whether the object to be detected is a living body or partial tissues thereof, which is not limited in the present disclosure.

In the embodiments of the present disclosure, by disposing the induction assembly 210, the detection module 200 may detect the second voltage signal when the object to be detected approaches the liveness detection circuit 10, based on the first voltage signal, and then may judge whether the object to be detected is alive based on the first voltage signal and the second voltage signal, i.e., the detection module 200 may detect whether the object to be detected is alive through a non-contact detection solution, thereby improving the security and the reliability of the biometric detection. Moreover, the detection solution of the liveness detection circuit 10 including the signal generation module 100 and the detection module 200 is simple, and may be embedded in any biometric detection chip or device, so that the liveness detection circuit 10 has a higher applicability.

In some embodiments of the present disclosure, the signal generation module 100 may include a frequency-adjustable sine wave generator, which is configured to output a fixed-frequency sine wave or a variable-frequency sine wave. Through the frequency-adjustable sine wave generator, the induction assembly may be provided with an alternating magnetic field, and then an environmental basis may be provided to produce an eddy current effect between the induction assembly and the object to be detected.

In some embodiments of the present disclosure, the induction assembly 210 may include an induction coil 211, an impedance of the induction coil 211 changes when the object to be detected approaches.

It can be understood that the first voltage signal output by the signal generation module 100 may be an alternating voltage, such as a sine wave voltage signal. Further, when the object to be detected approaches the induction assembly 210, an eddy current effect may be produced between the induction assembly 210 and the object to be detected, so that under the eddy current effect, the impedance of the induction coil 211 changes, and the voltage across the induction coil 211 also changes. At this time, the detection module 200 detects a second voltage signal, and may judge whether the object to be detected is alive based on the detected second voltage signal and the first voltage signal output by the signal generation module 100. In which, a principle of the eddy current effect may be as illustrated in FIG. 2, and a working principle of the detection module 200 in the embodiments of the present disclosure is introduced below with reference to FIG. 2.

Referring to FIG. 2, when alternating current I₁ passes through the induction coil 211, an alternating magnetic field H₁ is generated around the induction coil 211 to act on a metallic body, but the alternating magnetic field H₁ cannot penetrate the metallic body with a certain thickness due to a skin effect, and only acts on a thin surface layer of the metal. Under the alternating magnetic field, induced current I₂ is generated on the metal surface, which is eddy current. The induced current also generates an alternating magnetic field H₂ to reactively counter-couples to the induction coil 211, and the direction of the alternating magnetic field H₂ is opposite to that of the original magnetic field in the induction coil 211. The superposition of these two magnetic fields is equivalent to changing the impedance or the electrical inductance of the induction coil, and the change of the impedance or the electrical inductance is only related to a resistivity and a permeability u of a metallic conductor, an excitation current intensity i, a frequency f, a geometric configuration r of the coil and a distance d between the induction coil 211 and the metallic conductor. When the induction coil 211 and the distance are fixed and the excitation current is constant, an impedance Z is only related to the resistivity and the permeability of the metallic conductor. Considering that a living object to be detected is also a conductor and produces an eddy current effect, by taking the advantage of a characteristic that the resistivity and the permeability of the living object to be detected are different from those of a non-living object, the detection module 200 may judge whether the object to be detected is alive by utilizing the eddy current effect.

In the embodiments of the present disclosure, the detection module 200 judges whether the object to be detected is alive according to the differences in the resistivity and the permeability of the conductor when the object to be detected is a living object and a non-living object respectively, in a non-contact manner by utilizing the eddy current effect, and the liveness detection circuit 10 is composed of the signal generation module 100 and the detection module 200 which is provided with the induction coil 211, so that the structure is simple and compact, and the Liveness detection circuit 10 may be embedded in any biometric detection chip or device. Therefore, the applicability is high, and the security and the reliability of the corresponding biometric detection chip or device can be improved.

In some embodiments of the present disclosure, the detection module 200 may include a detection and amplifier unit 220 and a processing unit 230, and the induction assembly 210 includes an induction coil 211.

An output end of the signal generation module 100 is connected to a first end of the induction coil 211 and a first input end of the detection and amplifier unit 220, a second input end of the detection and amplifier unit 220 is grounded, a second end of the induction coil 211 is connected to an output end of the detection and amplifier unit 220, and the output end of the detection and amplifier unit 220 is connected to the processing unit 230. The detection and amplifier unit 220 is configured to detect and amplify a voltage across the induction coil 211 and output the second voltage signal. The processing unit 230 is configured to judge whether the object to be detected is alive based on the first voltage signal and the second voltage signal. The induction coil 211 is configured to generate excitation current which is alternating current, based on the first voltage signal.

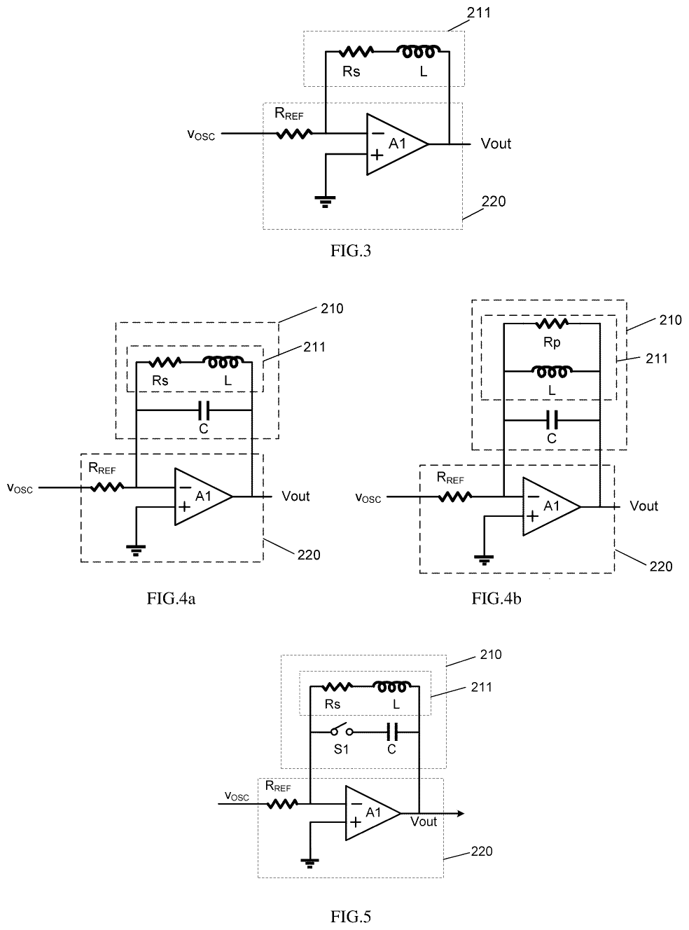

Exemplarily, the induction coil 211 may be regarded as an inductor with a loss resistor such as that illustrated in FIG. 3. At this time, the induction coil 211 may be equivalent to a series connection of a loss resistor Rs and an inductor L. At this time, the signal generation module may output a first voltage signal Vosc characterized as a sine wave with a fixed frequency, and the inductor L is in an alternating circuit. When the object to be detected approaches the inductor L, the inductor L may produce an eddy current effect with the object to be detected. At this time, an impedance Z of the induction coil 211 composed of the loss resistor Rs and the inductor L changes. The detection and amplifier unit 220 detects a voltage across the loss resistor Rs and the inductor L connected in series, and amplifies the voltage to obtain a second voltage signal Vout. The processing unit 230 may calculate the impedance Z of the induction coil 211 based on the second voltage signal output by the detection and amplifier unit and the first voltage signal output by the signal generation module, and may determine whether the object to be detected is alive based on the determined impedance Z and a preset impedance.

In some embodiments of the present disclosure, the induction assembly 210 may further include an inductive capacitor C, a first end of which is connected to the first end of the induction coil 211, and a second end of which is connected to the second end of the induction coil 211.

Exemplarily, the induction coil 211 may be regarded as an inductor with a loss resistor. Referring to the loss resistor Rs and the inductor L in FIG. 4a, the induction coil 211 may be equivalent to the series connection of the loss resistor Rs and the inductor L. The inductive capacitor C may be connected in parallel across the series combination of the loss resistor Rs and the inductor L. At this time, the signal generation module 100 may output a first voltage signal Vosc characterized by a sine wave with a variable frequency. Further, when the object to be detected approaches the induction coil 211, an eddy current effect occurs between the object to be detected and the induction coil 211, and when a resonance occurs, the induction coil 211 may be equivalent to a parallel connection between a resistor Rp and the inductor L, as illustrated in FIG. 4b, and at the resonance frequency, the impedance of the induction coil 211 reaches its peak value, equal to the resistance value of Rp. At this time, the detection and amplifier unit 220 may output a second voltage signal Vout, and when judging whether the object to be detected is alive based on the first voltage signal and the second voltage signal, the processing unit 230 may determine the impedance Z of the induction coil 211 based on the first voltage signal and the second voltage signal, and determine whether the object to be detected is alive based on the determined impedance Z and a preset impedance.

It can be understood that when the signal generation module outputs the variable-frequency first voltage signal or the first voltage signal with a fixed frequency, the preset impedances involved in judging whether the object to be detected is a living body are different, and the preset reactance when the first voltage signal with a variable frequency is output is greater than that that when the first voltage signal with a fixed frequency is output.

Further, in order to improve the flexibility and the applicability of the induction assembly, a switch may be disposed in the induction assembly, and then the signal generation module may be adjusted to output the first voltage signal with a variable frequency or the second voltage signal with a fixed frequency by switching the switch.

Referring to FIG. 5, exemplarily, the induction assembly 210 may further include a switch S1 and an inductive capacitor C; a first end of the switch S1 is connected to the first end of the induction coil 211, a second end of the switch S1 is connected to a first end of the induction capacitor C, and a second end of the induction capacitor C is connected to the second end of the induction coil 211. That is, the switch S1 is connected in series with the capacitor C, and the combination thereof are then connected in parallel across the series combination of inductor L and the loss resistor Rs. Through the closing or opening of the switch S1 and a control instruction output to the signal generation module, the signal generation module can output the first voltage signal Vosc with a variable frequency or the first voltage signal Vosc with a fixed frequency.

In some embodiments of the present disclosure, the closing or opening of the switch S1 and the generation of the control instruction of the signal generation module may be realized by a control unit, such as the processing unit 230 or any other control circuit. Further, when the switch S1 is controlled to be closed, a control instruction for outputting the first voltage signal with a variable frequency may be synchronously sent to the signal generation module, so that the induction assembly 210 in FIG. 5 may be equivalent to that illustrated in FIG. 4a. In addition, when the object to be detected approaches the induction assembly, an eddy current effect is produced between the induction assembly and the object to be detected. When a resonance occurs, the induction assembly in FIG. 5 may be equivalent to that illustrated in FIG. 4b, and the detection and amplifier unit 220 outputs a second voltage signal. At this time, the processing unit 230 may calculate an impedance of the induction assembly based on the first voltage signal and the second voltage signal, and compare the impedance with a first preset impedance to judge whether the object to be detected is a living body. When the switch S1 is controlled to be opened, a control instruction for outputting the first voltage signal with a fixed frequency may be synchronously sent to the signal generation module, so that the induction assembly 210 in FIG. 5 may be equivalent to that illustrated in FIG. 3. When the object to be detected approaches the induction assembly, an eddy current effect is produced between the induction assembly and the object to be detected, and the detection and amplifier unit 220 outputs a second voltage signal. At this time, the processing unit 230 may calculate an impedance of the induction assembly based on the first voltage signal and the second voltage signal, and compare the impedance with a second preset impedance to judge whether the object to be detected is a living body.

In some embodiments of the present disclosure, the closing or opening of the switch S1 may also be realized by the signal interaction between the switch and the signal generation module. That is, the signal generation module may send a relevant instruction for controlling the switch S1 to be closed or opened to the switch S1 based on whether the generated first voltage signal is a signal with a variable frequency. In other embodiments, the closing or opening of the switch S1 and the generation of the control instruction of the signal generation module may also be realized in any other way, which is not limited in the present disclosure.

Of course, those skilled in the art may dispose other electrical elements in the induction assembly 210 as required, such as adding other element to improve the accuracy, the reliability and the applicability of the liveness detection circuit. In the embodiment of the present disclosure, a non-contact liveness detection is realized by detecting the changes of the impedance and the permeability of the induction coil through the eddy current effect between the induction coil and the object to be detected. Any other modification, equivalent substitution, improvement, etc. made within this principle should be included in the scope of the claims of the present disclosure.

Referring to FIGS. 3 to 4b, in some embodiments of the present disclosure, the detection and amplifier unit 220 may include a first operational amplifier A1, a negative input end of which is connected to the first end of the induction coil 211 and the output end of the signal generation module 100, a positive input end of the first operational amplifier A1 is grounded, and an output end of the first operational amplifier A1 is connected to the second end of the induction coil 211 and the processing unit 230.

In some embodiments of the present disclosure, the detection and amplifier unit 220 may further include a reference resistor R_{REF}, and the output end of the signal generation module 100 is connected to the negative input end of the first operational amplifier A1 through the reference resistor R_{REF}.

In some embodiments of the present disclosure, in a case where the detection and amplifier unit adopts the first operational amplifier A1 and the reference resistor R_{REF}, when the induction coil 211 detects that the impedance changes as the object to be detected approaches, the impedance of the induction coil or of the induction assembly may be calculated based on a transfer function of the detection and amplifier unit 220. Taking the circuit in FIGS. 4a to 4b as an example, the transfer function may be expressed by Formula (1):

$$\frac{{v}_{out}}{{v}_{osc}} = - \frac{\frac{Z ( s )}{{R}_{REF} + Z ( s )}}{\frac{{R}_{REF} + {R}_{REF} A ( s ) + Z ( s )}{{R}_{REF} + Z ( s )}} A ( s ) = - \frac{Z ( s )}{{R}_{REF}} \frac{β A}{1 + A β} \qquad Formula ( 1 )$$

where vₒᵤₜ may represent a second voltage signal, v_{osc} may represent a first voltage signal, R_{REF} may represent a resistance value of the reference resistor, A(s) and A may represent an amplification factor of the first operational amplifier, and Z(s) may represent an impedance of the induction assembly.

Through the above Formula (1), based on a voltage value of the second voltage signal output by the detection and amplifier unit 220 and a voltage value of the first voltage signal output by the signal generation module 100, a value of a maximum impedance Z of the induction coil at the resonance frequency

$$\frac{1}{\sqrt{LC}}$$

may be calculated. Further, the calculated Z may be compared with a preset impedance corresponding to the first voltage signal with a variable frequency, so as to judge whether the object to be detected is alive.

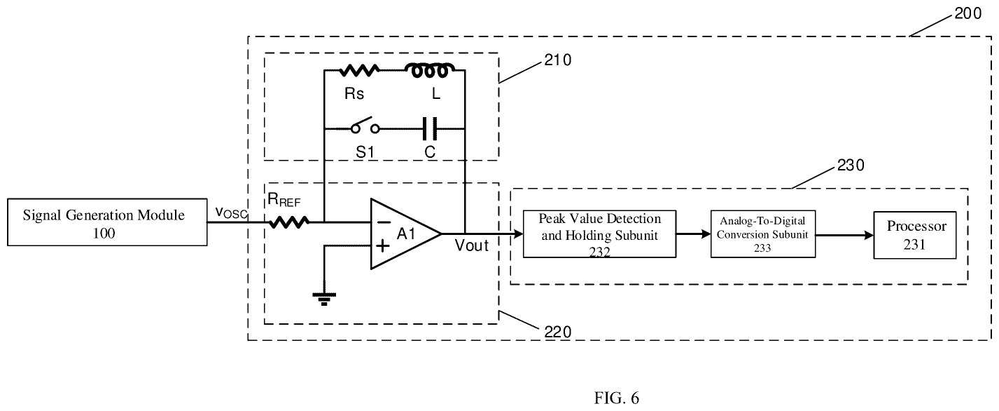

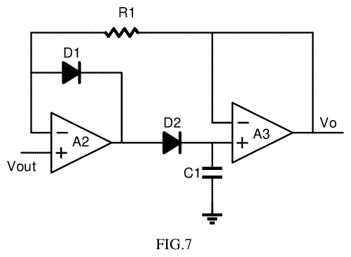

Referring to FIG. 6, in some embodiments of the present disclosure, the processing unit 230 may include a processor 231 configured to determine an impedance of the induction assembly 210 based on the first voltage signal and the second voltage signal, and judge whether the object to be detected is alive based on the impedance of the induction coil and a preset impedance.

Exemplarily, in order to facilitate the calculation of the impedance of the induction assembly, the processor 231 of the processing unit 230 may convert the first voltage signal and the second voltage signal into digital signals respectively, and calculate the impedance of the induction coil based on the converted digital signals, so as to improve the calculation speed and further improve the efficiency of the liveness detection.

Referring to FIG. 6, in some embodiments of the present disclosure, the processing unit 230 may include a peak value detection and holding subunit 232 and an analog-to-digital conversion subunit 233; the peak value detection and holding subunit 232 is configured to detect a peak value of the second voltage signal output by the detection and amplifier unit 220, and retain the peak value; the analog-to-digital conversion subunit 233 is configured to quantize the peak value to obtain a target signal, and send the target signal to an operation module, so that the operation module determines an impedance of the induction coil based on the target signal and the first voltage signal, and judges whether the object to be detected is alive based on the impedance of the induction coil and a preset impedance.

It can be understood that the signal generation module 100 outputs an alternating voltage signal with a fixed frequency or a variable frequency, and then the induction assembly also outputs an alternating voltage signal. That is, the second voltage signal output by the detection and amplifier unit is an alternating voltage signal, so that a peak value of the second voltage signal can be retained by the peak value detection and holding subunit 232. That is, the peak value detection and holding subunit 232 may detect the peak value of the second voltage signal, and hold and output the detected peak value, and then the analog-to-digital conversion subunit 233 may perform analog-to-digital conversion, i.e., quantization, on the peak value to obtain a digital target signal, and the obtained target signal may be output to the operation module to calculate the impedance.

In some embodiments of the present disclosure, the processing unit 230 may further include a processor 231, that is, the processing unit includes a peak value detection and holding subunit 232, an analog-to-digital conversion subunit 233 and a processor 231 which are connected in sequence. At this time, the operation module may be the processor 231, and the analog-to-digital conversion subunit 233 may output the converted target signal to the processor 231, and the processor 231 may calculate the impedance of the induction coil based on the target signal and the first voltage signal. Of course, the processor 231 may be replaced with any other module unit that can calculate the impedance and judge whether the object to be detected is alive, which is not limited in the present disclosure.

In some embodiments of the present disclosure, the processing unit may only include a peak value detection and holding subunit 232 and an analog-to-digital conversion subunit 233 which are connected in sequence, and then the operation module may be a module unit of any other chip, circuit or device which can calculate the impedance and judge whether the object to be detected is alive, such as a processor of a biometric sensing chip. At this time, the liveness detection circuit and the biometric sensing chip may share one processor, and the processor may control the output voltage signal of the signal generation module 100, i.e., control the signal generation module to output the first voltage signal with a fixed frequency or a variable frequency.

In some embodiments of the present disclosure, the analog-to-digital conversion subunit 233 may adopt an analog-to-digital converter (ADC), through which the peak value of the second voltage signal may be quantized. Further, the ADC may be a Successive Approximation Register (SAR) ADC with a medium resolution (about 10 bits), a medium or low speed (1M to 10M) and a saved area. In other embodiments, the analog-to-digital conversion subunit 233 may also be any other device that can quantize the voltage signal, which is not limited in the present disclosure.

Referring to FIG. 7, in some embodiments of the present disclosure, the peak value detection and holding subunit 232 may include a first diode D1, a second diode D2, a detection resistor R1, a detection capacitor C1, a second operational amplifier A2 and a third operational amplifier A3.

In which, a negative input end of the second operational amplifier A2 is connected to an anode of the first diode D1 and a first end of the detection resistor R1, a positive input end of the second operational amplifier A2 is connected to the output end of the detection and amplifier unit 220, and an output end of the second operational amplifier A2 is connected to a positive input end of the third operational amplifier A through the second diode D2; a cathode of the first diode D1 is connected to the output end of the second operational amplifier A2; a second end of the detection resistor R1 is connected to a negative input end of the third operational amplifier A3 and an output end of the third operational amplifier A3; a positive input end of the third operational amplifier A3 is grounded through the detection capacitor C1, and the output end of the third operational amplifier A3 is connected to an input end of the analog-to-digital conversion subunit 233. In which, the output of the third operational amplifier A3 is the peak value Vo of the second voltage signal detected and retained by the peak value detection and holding subunit.

The embodiments of the present disclosure further provide a liveness detection method, which is applied to the liveness detection circuit in FIG. 1, and the method may include:
a signal generation module generates a first voltage signal; and
a detection module detects a second voltage signal generated when an object to be detected approaches an induction assembly, based on the first voltage signal, and judges whether the object to be detected is alive based on the first voltage signal and the second voltage signal.

Exemplarily, the signal generation module may generate a first voltage signal based on an instruction of the processing unit of the detection module or any other control module. When the detection module receives the first voltage signal, an alternating magnetic field may be generated around the induction coil of the induction assembly, and when the object to be detected approaches the induction coil, an eddy current effect may be produced between the object to be detected and the induction coil, so that the impedance of the induction coil changes. The detection module may detect a voltage across the induction coil after the impedance thereof changes, i.e., a second voltage signal, and may judge whether the object to be detected is alive based on the first voltage signal generated by the signal generation module and the second voltage signal.

In some embodiments of the present disclosure, the step that the signal generation module generates the first voltage signal may include: the signal generation module generates a first voltage signal characterized as a sine wave with a variable frequency; accordingly, the step that the detection module judges whether the object to be detected is alive based on the first voltage signal and the second voltage signal may include: the detection module detects a peak value of the second voltage signal output by the induction assembly based on the first voltage signal, performs analog-to-digital conversion on the detected peak value, and determines a maximum value of the peak value as the second voltage signal based on an analog-to-digital conversion result; the detection module calculates a first impedance of the induction assembly based on the second voltage signal and the first voltage signal corresponding to the maximum value of the peak value; and the detection module judges whether the object to be detected is alive based on the first impedance of the induction assembly and a first preset impedance.

In some embodiments of the present disclosure, the step that the signal generation module generates the first voltage signal may include: the signal generation module generates a first voltage signal characterized as a sine wave with a fixed frequency; accordingly, the step that the detection module judges whether the object to be detected is alive based on the first voltage signal and the second voltage signal may include: the detection module detects a peak value of the second voltage signal output by the induction assembly, based on the first voltage signal, and performs analog-to-digital conversion on the peak value to obtain the second voltage signal; the detection module calculates a second impedance of the induction assembly based on the second voltage signal and the first voltage signal corresponding to the peak value; and the detection module judges whether the object to be detected is alive based on the second impedance of the induction assembly and a second preset impedance.

It can be understood that the signal generation module may generate a first voltage signal characterized by a sine wave with a variable frequency or a fixed frequency. When the signal generation module generates a first voltage signal characterized by a sine wave with a variable frequency, the induction assembly may at least include an induction coil and a capacitor connected in parallel therewith. When the signal generation module may generate a first voltage signal characterized by a sine wave with a fixed frequency, the induction assembly may at least include an induction coil. Further, the induction assembly may further include an induction coil, a switch and a capacitor which are connected in parallel with the induction coil, wherein the switch and the capacitor may be connected in series, and whether the capacitor is connected in the induction assembly may be controlled by controlling the closing or opening of the switch.

The specific composition and the specific working principle of each module in the above embodiments may refer to the relevant descriptions in the foregoing content, which will not be repeated here.

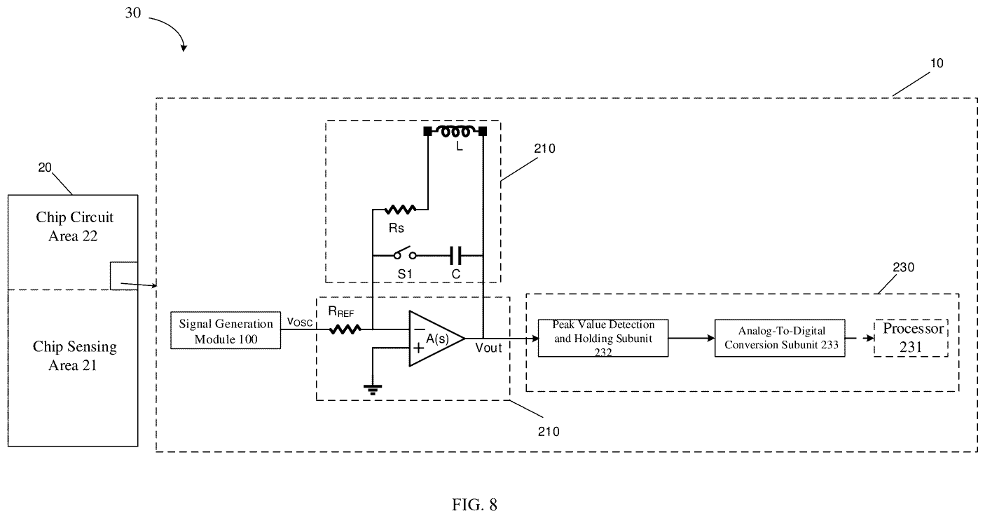

Referring to FIG. 8, the embodiments of the present disclosure further provide a biometric recognition device 30, which may include the liveness detection circuit 10 in FIG. 1 and a biometric sensing chip 20;
the biometric sensing chip 20 is configured to sense an object to be detected through a chip sensing area 21, and judge whether biological characteristics carried by the object to be detected matches preset biological characteristics; and
the Liveness detection circuit 10 is configured to generate a first voltage signal; detect a second voltage signal generated when the object to be detected approaches an induction assembly, based on the first voltage signal, and judge whether the object to be detected is alive based on the first voltage signal and the second voltage signal.

In which, the biometric sensing chip 20 may further include a chip circuit area 22 configured to integrate circuit elements of the biometric sensing chip.

It can be understood that the above biometric sensing chip may be any chip configured to sense whether the biological characteristics carried by the object to be detected matches the preset biological characteristics, such as various fingerprint chips including an optical fingerprint chip, a capacitive fingerprint chip, an ultrasonic fingerprint chip, etc., or a sensing chip for biometric recognitions such as face recognition, pupil recognition, etc., so as to detect whether the object to be detected is alive through the liveness detection circuit, and improve the security and the reliability of the biometric recognition.

In some embodiments of the present disclosure, the liveness detection circuit may be integrated into a biometric sensing chip (e.g., the chip circuit area 22 of the biometric sensing chip) as a part of the biometric sensing chip, so as to realize the liveness detection at the same time of biometric sensing. In other embodiments, the liveness detection circuit may also be directly integrated into a biometric recognition device 30, which may or may not be equipped with the biometric sensing chip, so that the liveness detection can be realized for the biometric recognition device 30.

In some embodiments of the present disclosure, the biometric sensing chip and the induction coil in the liveness detection circuit are disposed horizontally. It can be understood that in order to better realize the function of the liveness detection and ensure the eddy current effect between the induction coil and the object to be detected, it is necessary to dispose the biometric sensing chip and the induction coil horizontally. There may be no restriction on the positional relationship between any other element of the liveness detection circuit and the biometric sensing chip.

In which, the biometric sensing chip and the induction coil may be disposed in a same horizontal plane. Exemplarily, the biometric sensing chip and the induction coil may be disposed on a same substrate. For example, all elements in the liveness detection circuit including the induction coil are integrated on the substrate where the biometric sensing chip is located. The biometric sensing chip and the induction coil may also be simultaneously disposed on a cover plate of the biometric recognition device 30, so as to minimize the distance from the induction coil and the biometric recognition chip to the object to be detected, and the biometric sensing chip and the induction coil may be disposed on a same cover plate, so as to facilitate the integration of the biometric sensing chip and the liveness detection circuit. The biometric sensing chip and the induction coil may also be disposed on a same horizontal plane in other ways, so that there is no overlap therebetween to avoid the mutual interference of signals.

Although the processes described above includes a plurality of operations occurring in a particular order, it should be clearly understood that those processes may include more or less operations which may be performed sequentially or in parallel (e.g., using a parallel processor or a multi-threaded environment).

The present disclosure is described with reference to a flowchart and/or a block diagram of the method, device (system) and computer program product according to the embodiments of the present disclosure. It shall be appreciated that each flow and/or block in the flowchart and/or the block diagram and a combination of flows and/or blocks in the flowchart and/or the block diagram can be realized by computer program instructions. Those computer program instructions can be provided to a general computer, a dedicated computer, an embedded processor or a processor of other programmable data processing device to produce a machine, so that the instructions executed by the processor of the computer or other programmable data processing device produce means for realizing specified functions in one or more flows in the flowchart and/or one or more blocks in the block diagram.

These computer program instructions may be stored in a computer readable memory capable of guiding the computer or other programmable data processing devices to work in a particular way, so that the instructions stored in the computer readable memory can produce manufacture articles including an instructing device which realizes function(s) specified in one or more flows in the flowchart and/or one or more blocks in the block diagram.

These computer program instructions may also be loaded onto the computer or other programmable data processing devices, so that a series of operation steps are performed on the computer or other programmable data processing devices to produce a processing realized by the computer, thus the instructions executed on the computer or other programmable devices provide step(s) for realizing function(s) specified in one or more flows in the flowchart and/or one or more blocks in the block diagram.

The computer-readable medium includes permanent and non-permanent, removable and non-removable media, which can realize the information storage in any method or technique. The information can be computer readable instructions, data structures, program modules or other data. An example of the computer storage medium includes, but not limited to, a phase change memory (PRAM), a static random access memory (SRAM), a dynamic random access memory (DRAM), other types of random access memory (RAM), a read-only memory (ROM), an electrically-erasable programmable read-only memory (EEPROM), a flash memory or other memory techniques, a compact disk read only memory (CD-ROM), a digital versatile disc (DVD) or other optical storages, magnetic cassette tapes, magnetic diskettes or other magnetic storage device or any other non-transmission medium, which can be used for the storage of information accessible to a computing device. According to the definitions herein, the computer readable medium does not include any temporary computer readable media (transitory media), such as modulated data signal and carrier wave.

Those skilled in the art should appreciate that any embodiment of the present disclosure can be provided as a method, a system or a computer program product. Therefore, the embodiment of present disclosure can take the form of a full hardware embodiment, a full software embodiment, or an embodiment combining software and hardware. Moreover, the embodiment of the present disclosure can take the form of a computer program product implemented on one or more computer usable storage mediums (including, but not limited to, a magnetic disc memory, CD-ROM, optical storage, etc.) containing therein computer usable program codes.

The embodiments of the present disclosure are all described in a progressive manner, and the same or similar portions of the embodiments can refer to each other. Each embodiment lays an emphasis on its distinctions from other embodiments. In particular, the system embodiment is simply described since it is substantially similar to the method embodiment, and please refer to the descriptions of the method embodiment for the relevant part. In the description of the present disclosure, the description of reference terms “one embodiment”, “some embodiments”, “an example”, “a specific example” or “some examples” or the like mean that the specific features, structures, materials, or characteristics described in conjunction with the embodiment(s) or example(s) are included in at least one embodiment or example of the present disclosure. In the present disclosure, the schematic expressions of the above terms do not necessarily aim at the same embodiment or example. Moreover, the described specific features, structures, materials, or characteristics may be combined in any one or more embodiments or examples in a suitable manner. In addition, those skilled in the art can combine different embodiments or examples described in the present disclosure and features thereof if there is no contradiction to each other.

Those described above are just optional embodiments of the present disclosure, rather than limitations to the present disclosure. For those skilled in the art, the present disclosure is intended to cover any amendment or variation. Any amendment, equivalent substitution, improvement, etc. made under the spirit and principle of the present disclosure should fall within the scope of the claims of the present disclosure.

What is claimed is:

1. A liveness detection circuit, comprising: a signal generation module, and a detection module with an induction assembly, the signal generation module configured to generate a first voltage signal and the detection module configured to detect a second voltage signal generated when an object to be detected approaches the induction assembly, based on the first voltage signal, and judge whether the object to be detected is alive based on the first voltage signal and the second voltage signal.

2. The liveness detection circuit according to claim 1, wherein the induction assembly comprises an induction coil, wherein impedance of the induction coil changes when the object to be detected approaches.

3. The liveness detection circuit according to claim 1, wherein the detection module comprises a detection and amplifier unit and a processing unit, wherein the induction assembly comprises an induction coil,
wherein an output end of the signal generation module is connected to a first end of the induction coil and a first input end of the detection and amplifier unit, a second input end of the detection and amplifier unit is grounded, a second end of the induction coil is connected to an output end of the detection and amplifier unit, and the output end of the detection and amplifier unit is connected to the processing unit,
wherein the detection and amplifier unit is configured to detect and amplify a voltage across the induction coil and output the second voltage signal, and the processing unit is configured to judge whether the object to be detected is alive based on the first voltage signal and the second voltage signal, and
wherein the induction coil is configured to generate an excitation current, based on the first voltage signal, wherein the generated excitation current is an alternating current.

4. The liveness detection circuit according to claim 3, wherein the induction assembly further comprises an induction capacitor;
wherein a first end of the induction capacitor is connected to the first end of the induction coil and a second end of the induction capacitor is connected to the second end of the induction coil.

5. The liveness detection circuit according to claim 3, wherein the induction assembly further comprises a switch and an induction capacitor, wherein a first end of the switch is connected to the first end of the induction coil, a second end of the switch is connected to a first end of the induction capacitor, and a second end of the induction capacitor is connected to the second end of the induction coil.

6. The liveness detection circuit according to claim 3, wherein the detection and amplifier unit comprises a first operational amplifier, wherein a negative input end of which is connected to the first end of the induction coil and the output end of the signal generation module, wherein a positive input end of the first operational amplifier is grounded, wherein an output end of the first operational amplifier is connected to the second end of the induction coil and the processing unit.

7. The liveness detection circuit according to claim 3, wherein the processing unit comprises a processor configured to determine an impedance of the induction coil based on the first voltage signal and the second voltage signal and judge whether the object to be detected is alive based on the impedance of the induction coil and a preset impedance.

8. The liveness detection circuit according to claim 3, wherein the processing unit comprises a peak value detection unit and an analog-to-digital conversion unit,
wherein the peak value detection unit is configured to detect a peak value of the second voltage signal output by the detection and amplifier unit and retain the peak value,
wherein the analog-to-digital conversion unit is configured to quantize the peak value to obtain a target signal and send the target signal to an operation module of the processor so that the operation module of the processor determines an impedance of the induction coil based on the target signal and the first voltage signal and judges whether the object to be detected is alive based on the impedance of the induction coil and a preset impedance.

9. The liveness detection circuit according to claim 8, wherein the peak value detection and holding subunit comprises a first diode, a second diode, a detection resistor, a detection capacitor, a second operational amplifier and a third operational amplifier,
wherein a negative input end of the second operational amplifier is connected to an anode of the first diode and a first end of the detection resistor, wherein a positive input end of the second operational amplifier is connected to the output end of the detection and amplifier unit, and wherein an output end of the second operational amplifier is connected to a positive input end of the third operational amplifier through the second diode;
wherein a cathode of the first diode is connected to the output end of the second operational amplifier,
wherein a second end of the detection resistor is connected to a negative input end of the third operational amplifier and an output end of the third operational amplifier, and
wherein a positive input end of the third operational amplifier is grounded through the detection capacitor and the output end of the third operational amplifier is connected to an input end of the analog-to-digital conversion subunit.

10. The liveness detection circuit according to claim 1, wherein the signal generation module comprises a frequency-adjustable sine wave generator configured to output a fixed-frequency sine wave or a variable-frequency sine wave.

11. A liveness detection method applied to a liveness detection circuit, the method comprising:
generating, by a signal generation module, a first voltage signal;
detecting, by a detection module, a second voltage signal generated when an object to be detected approaches an induction assembly, based on the first voltage signal; and
judging whether the object to be detected is alive based on the first voltage signal and the second voltage signal,
wherein the liveness detection circuit comprises: a signal generation module and a detection module with an induction assembly,
wherein the signal generation module is configured to generate a first voltage signal,
wherein the detection module is configured to detect a second voltage signal generated when an object to be detected approaches the induction assembly, based on the first voltage signal, and judge whether the object to be detected is alive based on the first voltage signal and the second voltage signal.

12. The liveness detection method according to claim 11, wherein generating, by a signal generation module, a first voltage signal comprises:
generating, by the signal generation module, a first voltage signal characterized by a variable-frequency sine wave;
judging, by the detection module, whether the object to be detected is alive based on the first voltage signal, wherein the second voltage signal comprises:
detecting, by the detection module, a peak value of the second voltage signal output by the induction assembly based on the first voltage signal;
performing analog-to-digital conversion on the detected peak value; and
determining a maximum value of the peak value as the second voltage signal based on an analog-to-digital conversion result;
calculating, by the detection module, a first impedance of the induction assembly based on the second voltage signal and the first voltage signal corresponding to the maximum value of the peak value; and
judging, by the detection module, whether the object to be detected is alive based on the first impedance of the induction assembly and a first preset impedance.

13. The liveness detection method according to claim 11, wherein the generating, by a signal generation module, a first voltage signal comprises:
generating, by the signal generation module, a first voltage signal characterized as a fixed-frequency sine wave;
judging, by the detection module, whether the object to be detected is alive based on the first voltage signal and the second voltage signal comprises:
detecting, by the detection module, a peak value of the second voltage signal output by the induction assembly based on the first voltage signal;
performing analog-to-digital conversion on the peak value to obtain the second voltage signal;
calculating, by the detection module, a second impedance of the induction assembly based on the second voltage signal and the first voltage signal corresponding to the peak value; and
judging, by the detection module, whether the object to be detected is alive based on the second impedance of the induction assembly and a second preset impedance.

14. A biometric recognition device, comprising: the liveness detection circuit, and a biometric sensing chip,
the biometric sensing chip configured to sense an object to be detected through a chip sensing area and judge whether biological characteristics carried by the object to be detected matches preset biological characteristics, and
the liveness detection circuit configured to generate a first voltage signal, detect a second voltage signal generated when the object to be detected approaches an induction assembly, based on the first voltage signal, and judge whether the object to be detected is alive based on the first voltage signal and the second voltage signal,
wherein the liveness detection circuit comprises: a signal generation module and a detection module with an induction assembly,
wherein the signal generation module is configured to generate a first voltage signal,
wherein the detection module is configured to detect a second voltage signal generated when an object to be detected approaches the induction assembly, based on the first voltage signal, and judge whether the object to be detected is alive based on the first voltage signal and the second voltage signal.

15. The biometric recognition device according to claim 14, wherein the biometric sensing chip and an induction coil in the liveness detection circuit are disposed horizontally.

16. The liveness detection method according to claim 14, wherein the induction assembly comprises an induction coil, wherein an inductive impedance of the induction coil changes when the object to be detected approaches.

17. The liveness detection method according to claim 14, wherein the detection module comprises a detection and amplifier unit and a processing unit, wherein the induction assembly comprises an induction coil,
wherein an output end of the signal generation module is connected to a first end of the induction coil and a first input end of the detection and amplifier unit, a second input end of the detection and amplifier unit is grounded, a second end of the induction coil is connected to an output end of the detection and amplifier unit, and the output end of the detection and amplifier unit is connected to the processing unit,
wherein the detection and amplifier unit is configured to detect and amplify a voltage across the induction coil and output the second voltage signal, wherein the processing unit is configured to judge whether the object to be detected is alive, based on the first voltage signal and the second voltage signal, and wherein the induction coil is configured to generate excitation current, based on the first voltage signal, wherein the generate excitation current is alternating current.

18. The liveness detection method according to claim 17, wherein the induction assembly further comprises a switch and an induction capacitor,
wherein a first end of the switch is connected to the first end of the induction coil, a second end of the switch is connected to a first end of the induction capacitor, and a second end of the induction capacitor is connected to the second end of the induction coil.

19. The biometric recognition device according to claim 14, wherein the induction assembly comprises an induction coil, wherein an inductive impedance of the induction coil changes when the object to be detected approaches.

20. The biometric recognition device according to claim 14, wherein the detection module comprises a detection and amplifier unit and a processing unit, wherein the induction assembly comprises an induction coil,
wherein an output end of the signal generation module is connected to a first end of the induction coil and a first input end of the detection and amplifier unit, a second input end of the detection and amplifier unit is grounded, a second end of the induction coil is connected to an output end of the detection and amplifier unit, and the output end of the detection and amplifier unit is connected to the processing unit,
wherein the detection and amplifier unit is configured to detect and amplify a voltage across the induction coil and output the second voltage signal, the processing unit is configured to judge whether the object to be detected is alive, based on the first voltage signal and the second voltage signal, and the induction coil is configured to generate excitation current, based on the first voltage signal, wherein the generate excitation current is an alternating current.
